(19) United States
(12) Patent Application Publication
(10) Pub. No.: US 2014/0257532 A1
(43) Pub. Date: Sep. 11, 2014

(54) APPARATUS FOR CONSTRUCTING DEVICE INFORMATION FOR CONTROL OF SMART APPLIANCES AND METHOD THEREOF

(71) Applicant: Electronics and Telecommunications Research Institute, Daejeon (KR)

(72) Inventors: Sung-Soo KIM, Daejeon (KR); Chunglae CHO, Daejeon (KR); Ji Yeon SON, Daejeon (KR); Jun Hee PARK, Daejeon (KR); Kwang Roh PARK, Daejeon (KR)

(21) Appl. No.: 13/907,725

(22) Filed: May 31, 2013

(30) Foreign Application Priority Data
Mar. 5, 2013 (KR) 10-2013-0023113

(51) Int. Cl. G05B 15/02

(52) U.S. Cl. CPC G05B 15/02
USPC 700/90; 348/46

(57) ABSTRACT

An apparatus for constructing device information for control of smart appliances includes a camera member, which generates multi-view images for 3D reconstruction through multi-angle photographing in an indoor space using a depth camera, and generates 3D data using the generated multi-view images, and a home device controller, which constructs a 3D space using the generated 3D data, and constructs a device profile for controlling an operation of a device to be controlled, which is designated by a user, through combination of spatial data of the device to be controlled and the constructed 3D space.

### RELATED APPLICATIONS(S)

This application claims the benefit of Korean Patent Application No. 10-2013-0023113, filed on Mar. 5, 2013, which is hereby incorporated by references as if fully set forth herein.

### FIELD OF THE INVENTION

The present invention relates to a technique of constructing device information for the control of smart appliances, and more particularly to an apparatus for constructing device information for the control of smart appliances and a method thereof, which are suitable for constructing control information of a designated device object in 3D space based on user gestures using a depth camera and a home device controller (or home device control set-top box).

### BACKGROUND OF THE INVENTION

With the development of technology related to a home network and various smart appliances, the control of smart appliances has evolved from a traditional graphic user interface (GUI) into a natural user interface (hereinafter referred to as “NUI”) through gestures, such as natural hand motions and the like, and users' demand for intuitive NUI has been rapidly increasing.

In particular, smart appliance control has been disassociated from integrated in-home appliance management control through a home gateway in the related art in a smart home environment, and has been developed in the form of an augmented-reality-based smart home device control system, with which a user can control appliances more easily through sensor technology for augmented reality and motion recognition.

Such a smart home device control service based on augmented reality is provided with more progressive functions through QR code extraction and recognition of appliances in images using a smart phone camera in a home network.

However, the service combined with augmented reality through the attachment of a QR code or a bar code for identification to the smart appliance and the service through user operation recognition using an IR sensor require separate QR code data construction and sensor equipment.

Further, in the case where a user intends to select and control a smart appliance, it is necessary to photograph the appliance to be controlled using a separate device to which a camera is attached, such as a smart phone, and then extract and analyze the QR code portion of the image.

Still another access method is a method of providing a service through a virtual 3D world, rather than the real world, for the control of smart appliances. Since this method selects and controls a virtual object, which is not a visible object in the real world, it is difficult to provide intuitive service to the user.

At present, as a control method provided through user's hand motion (gesture), there is a control method in which a user wears a glove, to which an infrared (IR) camera and an IR sensor (emitter) are attached, to control the smart appliances. However, this method requires that the user wears the separately manufactured glove, thus being inconvenient to use.

Accordingly, there is a need for the combination of indoor scene 3D information and smart appliance information to replace the QR mark attachment for identification of intuitive smart appliances and the IR sensor gloves for analyzing user's motions.

### SUMMARY OF THE INVENTION

First, according to the method in the related art, in which an image that is obtained by photographing a device to be controlled is transmitted using a smart phone having a camera attached thereto to a server that performs QR code identification to process the image, it is necessary to hold the smart phone in the hand, thus being inconvenient to use and having difficulty satisfying the criteria of NUI.

Further, it is difficult for a general user to directly attach the QR code for identifying information on the smart appliance to be controlled, thereby causing a problem, and this problem may occur in the case where the user intends to add a new smart appliance to a smart home.

In view of the above, the present invention provides a new technique, which can solve the problems and difficulties in identifying a device and providing a device control function based on user motion recognition in a system for providing an intuitive natural user interface (NUI) of a smart appliance connected to a home network, and construct information for controlling the device according to a user's gesture (e.g., hand motion) by combining configured 3D data about premises with device information using a home device controller connected to a depth camera.

Further, according to the present invention, since it is not necessary to attach the QR code for identifying the smart appliance, and since the user gesture recognition for constructing information about the smart appliance can be performed even without the IR sensor glove, control information that is necessary when controlling the smart appliance on the premises can be effectively constructed using a gesture-based intuitive natural user interface.

In accordance with the present invention, since the user reconstructs the 3D data about the premises in order to control the device to be controlled through the NUI in a smart home environment and constructs the data (device profile) by combining information about the attributes of a smart appliance (a device to be controlled) for each region, it is not necessary to attach the QR code for identifying the smart appliance, and from the viewpoint of the user interface, it is not necessary to wear a glove to which the IR sensor is attached, and thus a more flexible natural user interface can be provided.

Further, since the user can construct the 3D data about the smart home premises, and can directly designate and construct the control information about each smart appliance in a space, anyone can easily construct the data for controlling the smart appliance.

In accordance with an aspect of the present invention, there is provided an apparatus for constructing device information for control of smart appliances, which includes a camera member which generates multi-view images for 3D reconstruction through multi-angle photographing in an indoor space using a depth camera, and generates 3D data using the generated multi-view images, and a home device controller, which constructs a 3D space using the generated 3D data, and constructs a device profile for controlling an operation of a device to be controlled, which is designated by a user, through combination of spatial data of the device to be controlled and the constructed 3D space.

In the exemplary embodiment, the apparatus for constructing device information may includes a depth camera scan unit, which generates the images through the multi-angle photographing and capturing that scan the indoor space in upward, downward, left, and right directions, a multi-view image processing unit, which processes the images generated for construction of a 3D scene from the multi-view images, and a 3D data generation unit, which generates the 3D data through reconstruction of the processed multi-view images.

In the exemplary embodiment, the apparatus for constructing device information further may include a candidate region extraction unit, which extracts a candidate region of the device to be controlled in the 3D space that is constructed using the generated 3D data.

In the exemplary embodiment, the multi-view image processing unit may processes the multi-view images using an iterative closest point (ICP) algorithm.

In the exemplary embodiment, the multi-view image processing unit may processes the multi-view images using a random sample consensus (RANSAC) algorithm.

In the exemplary embodiment, the multi-view image may includes RGB information for representing colors by pixels that constitute the image and depth information.

In the exemplary embodiment, the user designation is a designation based on user gestures.

In the exemplary embodiment, the home device controller may includes a 3D data construction unit, which constructs the 3D space using the generated 3D data, a device search unit, which searches for the device to be controlled that exists in a home network and generates and provides a device list, and a device information combination unit, which constructs the device profile for controlling the operation of the device to be controlled through combination of device attribute information of the designated device to be controlled and information about a bounding region in the 3D space when any one of the devices to be controlled in the device list is designated.

In the exemplary embodiment, the device attribute information may includes 3D bounding box information, basic device information, detailed device information, device control GUI information, and device status information.

In accordance with another aspect of the exemplary embodiment of the present invention, there is provided a method for constructing device information for control of smart appliances, which includes generating multi-view images for 3D reconstruction through multi-angle photographing in an indoor space using a depth camera, and then generating 3D data using the generated multi-view images, and constructing a 3D space using the generated 3D data to express the 3D space on a display panel of a user terminal, and then constructing a device profile for controlling an operation of a device to be controlled through combination of attribute information of the device to be controlled and the 3D space.

In accordance with further another aspect of the exemplary embodiment of the present invention, there is provided a method for constructing device information for control of smart appliances, which includes generating multi-view images for 3D reconstruction through multi-angle photographing by a depth camera connected to a home network, generating 3D data using the generated multi-view images and displaying the 3D data on a display panel of a user terminal, determining a bounding region for a device to be controlled in a 3D space constructed through the 3D data, generating a device list through searching for the device to be controlled that exists in the home network and expressing the generated device list on the display panel, and constructing a device profile for controlling operation of the device to be controlled through combination of device attribute information of the designated device to be controlled and information of the bounding region when any one of the devices to be controlled in the generated device list is designated.

In the exemplary embodiment, the method for constructing device information further may includes constructing a new device profile for controlling the operation of the device through proceeding with a related process whenever a new device to be controlled among the devices to be controlled in the generated device list is designated.

In the exemplary embodiment, the method for constructing device information further may include storing the constructed device profile for controlling the operation of the device to be controlled in a profile DB.

In the exemplary embodiment, the constructing the device profile may includes acquiring box information of a 3D bounding region based on user designation, acquiring detailed device information about the device to be controlled that coincides with the corresponding bounding region, acquiring device control GUI information for controlling the corresponding device to be controlled, and generating the device profile for controlling the operation of the device to be controlled through combination of the acquired detailed device information and device control GUI information and the box information of the bounding region as the device attribute information.

### BRIEF DESCRIPTION OF THE DRAWINGS

The objects and qualities of the present invention will become apparent from the following description of embodiments given in conjunction with the accompanying drawings, in which:

FIG. 1 is a view summarizing a system for constructing device information for the control of smart appliances based on a NUI using a depth camera and a home device controller;

FIG. 2 is a block diagram of an apparatus for constructing device information for the control of smart appliances according to an embodiment of the present invention;

FIG. 3 is a conceptual view explaining that a user constructs device candidates to be controlled using indoor 3D data according to the present invention;

FIG. 4 is a flowchart illustrating a main process of constructing device information for the control of smart appliances according to an embodiment of the present invention; and

FIG. 5 is a flowchart illustrating a main process of constructing and registering a device profile in a device profile DB.

### DETAILED DESCRIPTION OF THE EMBODIMENTS

The aspects and qualities of the present invention and methods for achieving the aspects and qualities will be apparent by referring to the embodiments to be described in detail with reference to the accompanying drawings. Here, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims.

Further, in the following description of the present invention, a detailed description of known functions and configurations incorporated herein will be omitted when it may make the subject matter of the present invention rather unclear. Also, the following terms are defined in consideration of the functions of the present invention, and may be differently defined according to the intention of an operator or custom. Therefore, the terms should be defined based on the overall contents of the specification.

Hereinafter, preferred embodiments of the present invention will be described in detail with reference to the accompanying drawings.

### Embodiment 1

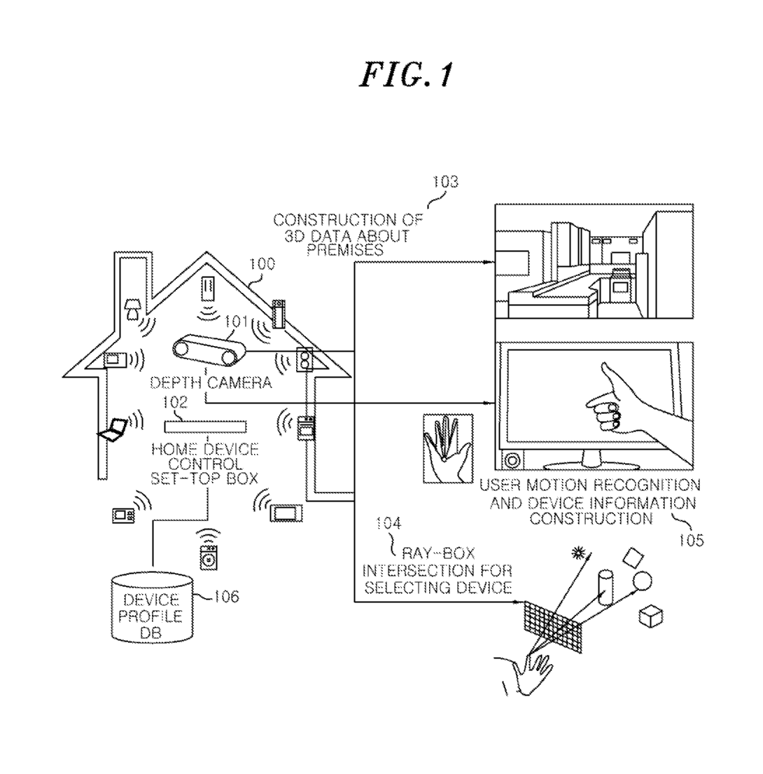

FIG. 1 is a view explaining a summary of a system for constructing device information for the control of smart appliances based on a NUI using a depth camera and a home device controller.

Referring to FIG. 1, the system briefly includes a depth camera 101, which is connected to a home network 100 of the premises, and a device controller (or home device control set-top box) 102. The home device controller 102 includes a device profile DB 106, and may serve to construct data (device profile data) for NUI-based control of smart appliances, such as a desktop PC, a notebook computer, a refrigerator, an air conditioner, an oven, and the like, in a smart home.

Here, the depth camera 101 can be automatically rotated in upward, downward, left, and right directions, may have a zoom-in/zoom-out photography function, and may be mounted in a corner of an indoor space, such as a living room, to generate multi-view images for 3D reconstruction through indoor multi-angle photography (scan photographing in the upward, downward, left, and right directions) and capturing. Respective pixels of each image may include not only RGB information for representing colors but also depth information.

The home device controller 102 may construct premises 3D data 103 using the multi-view images generated through the depth camera 101, and the processing of the multi-view images for constructing (generating) the premises 3D data may be performed (calculated) through application of methods using, for example, an iterative closest point (ICP) algorithm or a random sample consensus (RANSAC) algorithm.

Further, the home device controller 102 may store and manage the reconstructed 3D data. That is, the home device controller 102 may construct a 3D space using the premises 3D data, extract a candidate region for the smart appliance (device to be controlled) in the corresponding space, and store and manage the extracted information in a device profile DB 106 in the form of a 3D bounding box.

That is, if a user designates (selects) the corresponding smart appliance with a gesture (hand motion) in order to combine (match) attribute information (e.g., 3D bounding box information, basic device information, detailed device information, device control GUI information, device status information, and the like) of the smart appliance, which coincides with the candidate region, with the bounding region (candidate region), the depth camera 101 captures and transfers the corresponding scene image to the home device controller 102. The home device controller 102 calculates a vector in the 3D space that coincides with a user motion (gesture), and performs ray-box intersection 104 with respect to the bounding boxes in the indoor 3D data constructed in the previous step using the calculated vector. That is, the home device controller 102 may perform an information access and control function with respect to the smart appliance (device to be controlled) that exists in the smart home.

Thereafter, a smart appliance list (device list) that is provided from the home device controller 102 is expressed (displayed) on a display panel of a user terminal, such as a smart phone or a pad, and the user can designate (select) any one of the devices (smart appliances) to be controlled in the device list with the user gesture. When the user designates a desired smart appliance, the home device controller 102 detects (acquires) the attribute information of the corresponding smart appliance and combines (matches) the attribute information and the bounding region to construct the device profile (or device information) 105 for controlling the operation of the device to be controlled. The device profile data constructed as described above is registered (stored) in the device profile DB 106.

That is, according to the present invention, the device data (device profile) that can be used to control the NUI based smart appliances can be constructed by combining the premises (indoor) 3D data 103 and 3D spatial data of respective appliances using the depth camera 101 and the home device controller 102 based on the information of the smart appliances connected to the home network.

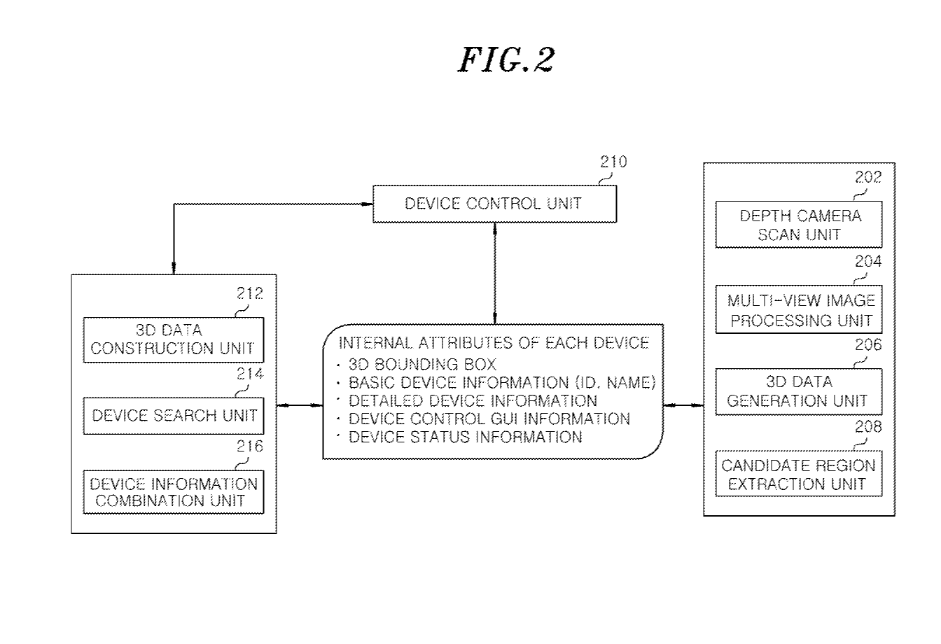

FIG. 2 is a block diagram of an apparatus for constructing device information for the control of smart appliances according to an embodiment of the present invention. The apparatus for constructing device information for the control of smart appliances according to an embodiment of the present invention may include a depth camera scan unit 202, a multi-view image processing unit 204, a 3D data generation unit 206, a candidate region extraction unit 208, a device control unit 210, a 3D data construction unit 212, a device search unit 214, and a device information combination unit 216.

Referring to FIG. 2, the depth camera scan unit 202, the multi-view image processing unit 204, the 3D data generation unit 206, and the candidate region extraction unit 208 may be defined as camera members that include, for example, the depth camera 101 of FIG. 1, and generate the multi-view images for the 3D reconstruction through multi-angle photography in the indoor space using, for example, the depth camera 101, and provide functions of generating the 3D data using the generated multi-view images.

Further, the device control unit 210, the 3D data construction unit 212, the device search unit 214, and the device information combination unit 216 may be defined as the home device controller 102 of FIG. 1, may construct a 3D space using the 3D data generated through the camera members, and may construct a device profile (device control information or device data) for controlling the operation of a device (smart appliance) to be controlled, which is designated by a user (e.g., user gesture based designation), by combining spatial data about the device to be controlled with the constructed 3D space.

Next, the depth camera scan unit 202 may generate the images through the multi-angle photography and capture, in which the indoor space is scanned in upward, downward, left, and right directions by the depth camera 101 of FIG. 1 (automatic rotation of the depth camera 101 in the upward, downward, left, and right directions), and may transfer the generated images to the multi-view image processing unit 204.

The multi-view image processing unit 204 may process the images for 3D scene construction, which are provided from the depth camera scan unit 202, as the multi-view images using, for example, an iterative closest point (ICP) algorithm or a random sample consensus (RANSAC) algorithm. The 3D data generation unit 206 may generate the 3D data through reconstruction of the processed multi-view images and then transfer the 3D data to the 3D data construction unit 212 in the home device controller 102.

Further, the candidate region extraction unit 208 may extract and store a candidate region of the device (smart appliance) to be controlled in the 3D space that is constructed using the 3D data generated through the 3D data generation unit 206 based on the user gesture (e.g., hand motion).

Additionally, the device control unit 210 includes a microprocessor that comprehensively controls various functions performed by the home device controller 102, and may generate various control commands to construct the device profile (device control information or device data) for controlling the operation of the device to be controlled according to the present invention to transfer the control commands to related constituent members.

Next, the 3D data construction unit 212 may construct the 3D space (or 3D scene) using the 3D data transferred from the 3D data generation unit 206 based on a control command provided from the device control unit 210, and may express (display) the constructed 3D scene on a display panel of a user terminal (not illustrated).

The device search unit 214 may search for the device (smart appliance) to be controlled that exists in the home network when the user gesture occurs in the 3D scene (space) that is expressed through the display panel of the user terminal, generate the device list (smart appliance list), and express the generated device list on the display panel of the user terminal. For this, the device search unit 214 may perform processes of acquiring box information of a 3D bounding region based on the user designation, acquiring detailed information about the device to be controlled that coincides with the corresponding bounding region, acquiring device control GUI information for controlling the corresponding device to be controlled, and acquiring device status information.

Lastly, the device information combination unit 216 may construct the device profile for controlling the operation of the device to be controlled by combining (mapping) information about the attributes of the designated device to be controlled and the information about the bounding box in the 3D space, and store the constructed device profile for controlling the operation of the device to be controlled in the device profile DB 106 when a desired one of the devices to be controlled in the device list (smart appliance list), which is generated by the device search unit 214 and is expressed on the display panel of the user terminal, is designated (selected).

Further, the device information combination unit 216 may construct a new device profile for controlling the operation through proceeding with a related process whenever a new device to be controlled among the devices to be controlled in the device list that is expressed on the display panel is designated through the user gesture, and may store the constructed device profile in the device profile DB 106.

Here, the attribute information (internal attribute information) of each device (smart appliance to be controlled) may include, for example, bounding box information (X_min, Y_min, Z_min, X_max, Y_max, Z_max) in an indoor 3D space of the corresponding smart appliance, basic device information (e.g., ID, name, and the like), detailed device information, device control GUI information that can be provided from the user terminal (e.g., smart phone, tablet, or the like), and information about the current status of the device.

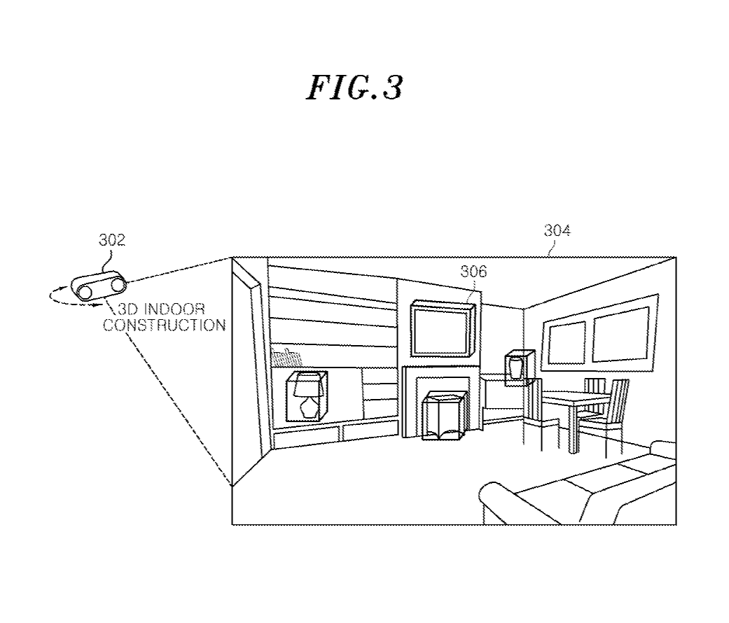

FIG. 3 is a conceptual view explaining that a user constructs device candidates to be controlled using indoor 3D data according to the present invention.

That is, referring to FIG. 3, the apparatus for constructing device information according to the present invention enables the user to construct device candidates to be controlled using the indoor 3D data that is constructed by the depth camera and the home device controller (home device control set-top box) connected to the home network. For this, the depth camera 302 generates the multi-view images through rotation and reconstructs the 3D data using the multi-view images.

Thereafter, the home device controller provides (expresses) the constructed 3D data to (on) the screen (display panel) of the user terminal through rendering 304 of the 3D data. The user may designate a region 306 of the smart appliance to be controlled based on the NUI on the corresponding screen and transmit the designated region to the home device controller. In response to this, the home device controller generates the device profile (device information) by combining (matching) the 3D data with the candidate region, and then stores and manages the device profile in a device profile DB.

Next, a series of processes of constructing device information (a device profile) for controlling the smart appliance using the apparatus for constructing device information having the above-described configuration according to the present invention will be described in detail.

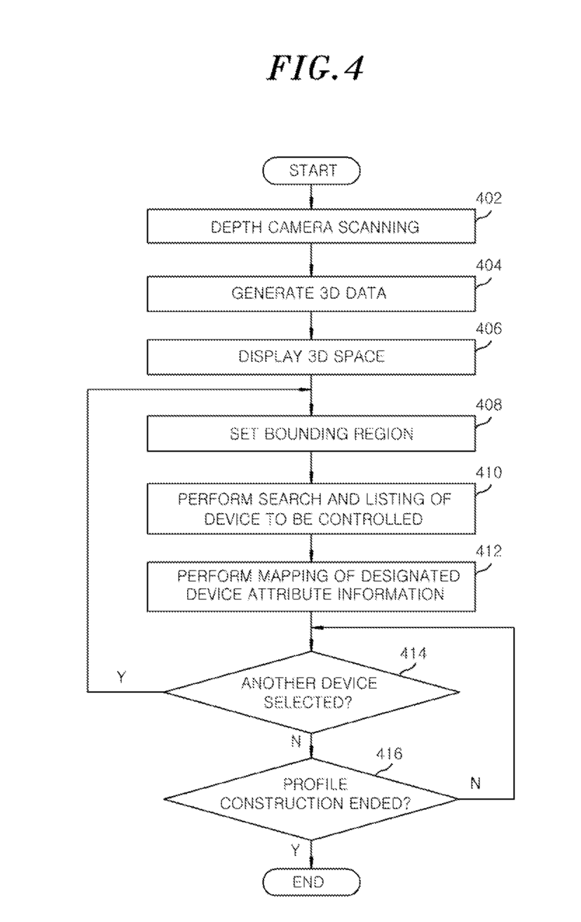

FIG. 4 is a flowchart illustrating a main process of constructing device information for the control of smart appliances according to an embodiment of the present invention.

Referring to FIG. 4, the depth camera scan unit 202 generates the images for constructing the 3D scene through the multi-angle photography (automatic scanning in upward, downward, left, and right directions) performed by the depth camera 101 connected to the home network and the capturing, and the multi-view image processing unit 204 processes the images generated using the ICP algorithm or the RANSAC algorithm as the multi-view image (step 402) for the 3D scene construction. Here, respective pixels of each image may include RGB information for representing the colors and the depth information.

Then, the 3D data generation unit 206 may generate the 3D data through reconstruction of the multi-view images processed through the 3D data generation unit 204 (step 404).

Then, the 3D data construction unit 212 constructs the 3D space (or 3D scene) using the 3D data based on the control command provided from the device control unit 210, and then expresses (displays) the constructed 3D space on the display panel of the user terminal (step 406).

Accordingly, the user can set a bounding region for the device that the user desires to control in the 3D space (3D scene) that is expressed on the display panel of the user terminal based on the gesture (hand motion) (step 408), and designate (select) the device (smart appliance) to be controlled.

Thereafter, if the user selects the device to be controlled after setting the bounding region through the gesture, the device search unit 214 generates the device list (smart appliance list) through searching for the device to be controlled that exists in the home network, and then expresses the device list (listing of the device list) on the display panel of the user terminal (step 410).

In response to this, when any one of the devices to be controlled in the device list, which is being expressed on the display panel of the user terminal, is designated (selected), the device information combination unit 216 may construct the device profile for controlling the operation of the device to be controlled by combining (mapping) information about the attributes of the designated device to be controlled with the box information about the bounding region in the 3D space, and may store the constructed device profile in the device profile DB 106 (step 412). Here, the attribute information (internal attribute information) about the device may include, for example, bounding box information (X_min, Y_min, Z_min, X_max, Y_max, Z_max) in an indoor 3D space of the corresponding smart appliance, basic device information (e.g., ID, name, and the like), detailed device information, device control GUI information that can be provided from the user terminal (e.g., smart phone, tablet, or the like), and information about the current status of the device.

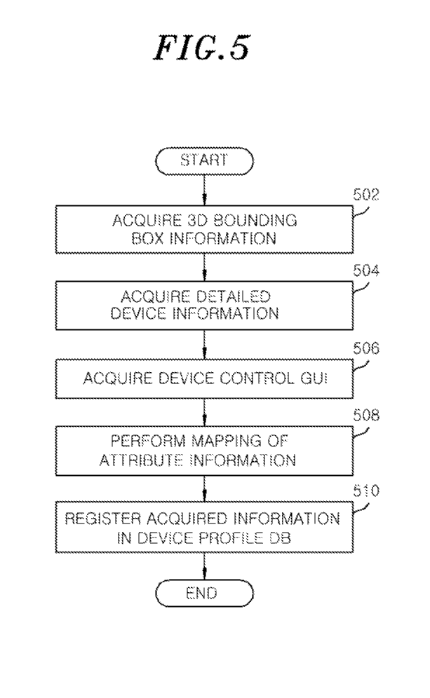

More specifically, as illustrated in FIG. 5 by way of example, the device search unit 214 acquires information about the 3D bounding box (step 502), acquires detailed information about the device that is to be controlled and that coincides with the corresponding bounding region (step 504), acquires device control GUI information for controlling the corresponding device to be controlled, and then transfers the acquired information to the device information combination unit 216 (step 506). In response to this, when any one of the devices to be controlled in the device list, which is being expressed on the display panel of the user terminal, is designated (selected), the device information combination unit 216 constructs the device profile (device information) for controlling the operation of the device to be controlled through mapping of the information about the attributes of the corresponding device to be controlled and the information about the bounding box in the 3D space (step 508), and registers the constructed device profile for controlling the operation in the device profile DB 106 (step 510).

Referring again to FIG. 4, the device control unit 210 monitors whether another device, for which it is intended to construct a device profile, is selected (step 414), or whether the user has finished the profile construction work (step 416). If it is determined that a new device (device for which it is intended to construct the device profile) is selected in the device list that is expressed on the display panel as the result of monitoring at step 414, the processing returns to the above-described step 408 to repeat the following processes, and the device profile for controlling the operation of the corresponding device, which is constructed through such processes, is registered in the device profile DB 106.

The description of the present invention as described above is merely exemplary, and it will be understood by those of ordinary skill in the art to which the present invention pertains that various changes in form and detail may be made therein without changing the technical idea or essential features of the present invention. Accordingly, it will be understood that the above-described embodiments are exemplary in all aspects, and do not limit the scope of the present invention.

Accordingly, the scope of the present invention is defined by the appended claims, and it will be construed that all corrections and modifications derived from the meanings and scope of the following claims and the equivalent concept fall within the scope of the present invention.

What is claimed is:

1. An apparatus for constructing device information for control of smart appliances, comprising:
a camera member, which generates multi-view images for 3D reconstruction through multi-angle photographing in an indoor space using a depth camera, and generates 3D data using the generated multi-view images; and
a home device controller, which constructs a 3D space using the generated 3D data, and constructs a device profile for controlling an operation of a device to be controlled, which is designated by a user, through combination of spatial data of the device to be controlled and the constructed 3D space.

2. The apparatus for constructing device information of claim 1, wherein the camera member comprises:
a depth camera scan unit, which generates the images through the multi-angle photographing and capturing that scan the indoor space in upward, downward, left, and right directions;
a multi-view image processing unit, which processes the images generated for construction of a 3D scene from the multi-view images; and
a 3D data generation unit, which generates the 3D data through reconstruction of the processed multi-view images.

3. The apparatus for constructing device information of claim 2, further comprising a candidate region extraction unit, which extracts a candidate region of the device to be controlled in the 3D space that is constructed using the generated 3D data.

4. The apparatus for constructing device information of claim 2, wherein the multi-view image processing unit processes the multi-view images using an iterative closest point (ICP) algorithm.

5. The apparatus for constructing device information of claim 2, wherein the multi-view image processing unit processes the multi-view images using a random sample consensus (RANSAC) algorithm.

6. The apparatus for constructing device information of claim 1, wherein the multi-view image includes RGB information for representing colors by pixels that constitute the image and depth information.

7. The apparatus for constructing device information of claim 1, wherein the user designation is a designation based on user gestures.

8. The apparatus for constructing device information of claim 1, wherein the home device controller comprises:
a 3D data construction unit, which constructs the 3D space using the generated 3D data;
a device search unit, which searches for the device to be controlled that exists in a home network and generates and provides a device list; and
a device information combination unit, which constructs the device profile for controlling the operation of the device to be controlled through combination of device attribute information of the designated device to be controlled and information about a bounding region in the 3D space when any one of the devices to be controlled in the device list is designated.

9. The apparatus for constructing device information of claim 8, wherein the device attribute information includes 3D bounding box information, basic device information, detailed device information, device control GUI information, and device status information.

10. A method for constructing device information for control of smart appliances, comprising:
generating multi-view images for 3D reconstruction through multi-angle photographing in an indoor space using a depth camera, and then generating 3D data using the generated multi-view images; and
constructing a 3D space using the generated 3D data to express the 3D space on a display panel of a user terminal, and then constructing a device profile for controlling an operation of a device to be controlled through combination of attribute information of the device to be controlled and the 3D space.

11. A method for constructing device information for control of smart appliances, comprising:
generating multi-view images for 3D reconstruction through multi-angle photographing by a depth camera connected to a home network;
generating 3D data using the generated multi-view images and displaying the 3D data on a display panel of a user terminal;
determining a bounding region for a device to be controlled in a 3D space constructed through the 3D data;
generating a device list through searching for the device to be controlled that exists in the home network and expressing the generated device list on the display panel; and
constructing a device profile for controlling operation of the device to be controlled through combination of device attribute information of the designated device to be controlled and information of the bounding region when any one of the devices to be controlled in the generated device list is designated.

12. The method for constructing device information of claim 11, wherein the multi-view image is acquired through scan photographing and capturing in upward, downward, left, and right directions in an indoor space where the depth camera is installed.

13. The method for constructing device information of claim 12, wherein the multi-view image includes RGB information for representing colors by pixels that constitute the image and depth information.

14. The method for constructing device information of claim 11, wherein the 3D data is generated through application of an iterative closest point (ICP) algorithm to the multi-view images.

15. The method for constructing device information of claim 11, wherein the 3D data is generated through application of a random sample consensus (RANSAC) algorithm to the multi-view images.

16. The method for constructing device information of claim 11, wherein the designation of the device to be controlled is a designation based on user gestures.

17. The method for constructing device information of claim 11, wherein the device attribute information includes 3D bounding box information, basic device information, detailed device information, device control GUI information, and device status information.

18. The method for constructing device information of claim 11, further comprising constructing a new device profile for controlling the operation of the device through proceeding with a related process whenever a new device to be controlled among the devices to be controlled in the generated device list is designated.

19. The method for constructing device information of claim 11, further comprising storing the constructed device profile for controlling the operation of the device to be controlled in a profile DB.

20. The method for constructing device information of claim 11, wherein the constructing the device profile comprises:
acquiring box information of a 3D bounding region based on user designation;
acquiring detailed device information about the device to be controlled that coincides with the corresponding bounding region;
acquiring device control GUI information for controlling the corresponding device to be controlled; and
generating the device profile for controlling the operation of the device to be controlled through combination of the acquired detailed device information and device control GUI information and the box information of the bounding region as the device attribute information.
